(19) United States
(12) Patent Application Publication
(10) Pub. No.: US 2006/0083909 A1
(43) Pub. Date: Apr. 20, 2006

(54) Easy-open dough packages and related methods of manufacture

(76) Inventors: David J. Matthews, Gilman, IL (US); Eric Paul Plourde, Homewood, IL (US); Brian Daniels, Battle Creek, MI (US)

Correspondence Address: Dennis M. Flaherty, Esq.;Ostrager Chong Flaherty & Broitman P.C., Suite 825, 250 Park Avenue, New York, NY, 10177-0899, US

(21) Appl. No.: 10/968,620

(22) Filed: Oct. 19, 2004

(51) Int. Cl. B31B 45/00; B65D 85/00

(52) U.S. Cl. 428/223; 426/106

(57) ABSTRACT

A generally tube-shaped package that has a tear strip joined to a web of packaging film, the tear strip incorporating an encapsulated tear notch. The package is filled with cookie or bread dough. In accordance with one embodiment, the tear strip is part of a tape that is joined to a web of packaging film. Preferably, the tear strip has a tear bead. Optionally, tearing off of the tear strip provides access to a peel seal, which in turn must be sundered to gain access to the dough. In accordance with another embodiment, the tear strip comprises a portion of a web of packaging film, which portion is bounded by a pair of mutually parallel capped tear lines. A tear bead is disposed between the tear lines. Methods of manufacturing such packages are disclosed.

### BACKGROUND OF THE INVENTION

This invention generally relates to packages having a tear strip for easy opening. In particular, the invention relates to easy-open packages for cookie or bread dough.

It is known to package dough in the shape of a cylinder with rounded ends. The dough is wrapped in a sheet or web of film, with excess film at the opposing ends of the dough being crimped closed using respective twisted metal wires. In accordance with one commercial product, the consumer is instructed to open the package by cutting off the opposing ends and then slitting the web of film along its length.

There is a need for packages for cookie or bread dough that are easy to open and can be manufactured at low cost.

### BRIEF DESCRIPTION OF THE INVENTION

The present invention is directed to a generally tube-shaped package that has a tear strip joined to a web of packaging film, the tear strip incorporating an encapsulated tear notch. The invention is further directed to methods of manufacturing such packages.

One aspect of the invention is a package comprising: a generally cylindrically shaped mass of dough comprising a central section and opposite ends; and a sealed enclosure that encloses the mass of dough a sealed enclosure that encloses said mass of dough and comprises a tear notch, wherein first and second portions of the sealed enclosure are fused together within a fused area that comprises first and second edges extending in parallel in opposite directions from opposing corners of a mouth of the tear notch.

Another aspect of the invention is a package comprising: a generally cylindrically shaped mass of material comprising a central section and opposite ends; a sealed enclosure that encloses the mass of material and comprises a tear notch; and a tear bead joined to the sealed enclosure and extending in a lengthwise direction along at least a portion of the length of the mass of material, wherein the sealed enclosure further comprises a fused area that comprises first and second edges extending in parallel in opposite directions from opposing corners of a mouth of the tear notch, the tear bead comprising first and second flattened portions in the fused area, the first flattened portion of the tear bead being adjacent the first edge of the fused area and the second flattened portion of the tear bead being adjacent the second edge of the fused area.

A further aspect of the invention is a package comprising: a mass of material comprising a central section and opposite ends; a length of a web of packaging material surrounding the mass of material, the length of the web comprising first and second edges that each extend from a respective point on one side of the central section to a respective point on the other side of the central section, and further comprising first and second marginal portions adjacent the first and second edges respectively; a length of tape comprising first and second portions that are joined to the first and second marginal portions respectively or to respective portions of the first and second marginal portions along the length of the web, and further comprising a third portion disposed between the first and second portions, the third portion of the length of tape being exposed and accessible to a consumer along a portion of the length of the web and comprising a fused area having or partly encircling a tear notch; and first and second closures for closing the joined web and tape at the opposite ends of the mass of material.

Yet another aspect of the invention is a package comprising: a mass of material comprising a central section and opposite ends; a length of a web of packaging material surrounding the mass of material, the length of the web comprising first and second edges that each extend from a respective point on one side of the central section to a respective point on the other side of the central section, and further comprising first and second marginal portions adjacent the first and second edges respectively, respective portions of the first and second marginal portions being joined to each other, and a portion disposed in the area between the first and second marginal portions and having first and second tear lines each comprising a respective series of spaced perforations; a length of a sealing strip that caps the perforations of the first and second tear lines; a length of tear bead joined to a portion of the sealing strip located between the first and second tear lines; and first and second closures for closing the at the opposite ends of the mass of material, wherein first and second portions of the sealing strip and a flattened portion of the tear bead are fused within a fused area having or partly encircling a tear notch.

Another aspect of the invention is a method of manufacture comprising the following steps: (a) guiding a web of packaging material in a machine direction through a vertical form-fill-seal (VFFS) machine with a portion of the web being wrapped around a tube; (b) fusing first and second portions of a length of tape together to form a fused area; (c) forming a tear notch in the fused area or in an area partly encircled by the fused area; (d) joining third and fourth portions of the length of tape to first and second portions of an equal length of the web to form a tube-shaped length of a tape-web assembly; (e) closing one end of the length of tape-web assembly at a location downstream from the tube; and (f) dropping product through the tube and onto the closed end.

A further aspect of the invention is a method of manufacture comprising the following steps: (a) forming first and second lines of spaced perforations in parallel in a web of packaging material; (b) joining a sealing strip to the web, the sealing strip capping the perforations; (c) joining a tear bead to the sealing strip; (d) guiding the web with the sealing strip and the tear bead thereon in a machine direction through a vertical form-fill-seal (VFFS) machine with a portion of the web being wrapped around a tube; (e) fusing first and second portions of the sealing strip and a flattened portion of the tear bead together to form a fused area; (f) forming a tear notch in the fused area or in an area partly encircled by said fused area; (g) closing one end of a length of the web at a location downstream from the tube; and (h) dropping product through the tube and onto the closed end.

Other aspects of the invention are disclosed and claimed below.

### BRIEF DESCRIPTION OF THE DRAWINGS

FIG. 1 is a drawing showing a front view of a package filled with dough in accordance with one embodiment of the present invention.

FIGS. 2 and 3 are drawings showing front and sectional views, respectively, of a length of tape-web assembly (open at both ends) suitable for being filled with dough and then closed at both ends.

FIG. 4 is a drawing showing an isometric view, with portions broken away, of an easy-open closure tape in accordance with known prior art.

FIG. 5 is a drawing showing an isometric view of the easy-open closure tape of FIG. 1 in a folded and partially opened state.

FIGS. 6 and 7 are drawings showing sectional views of respective easy-open closure tapes attached to a web of bag making film in accordance with respective embodiments of the invention.

FIG. 8 is a drawing showing the basic construction of a VFFS machine that can be adapted for making either of the embodiments depicted in FIGS. 6 and 7.

FIG. 9 is a drawing showing the basic construction of a VFFS machine that can be adapted for making alternative embodiments of the invention.

FIG. 10 is a drawing showing a sectional view of a web of bag making film having two lines of spaced perforations covered by a sealing strip, which in turn carries a tear bead, in accordance with another embodiment of the invention.

FIG. 11 is a drawing showing an elevational view of a VFFS machine in accordance with a further embodiment of the invention.

FIG. 12 is a drawing showing a top view of an apparatus for fusing and notching in accordance with yet another embodiment of the invention.

FIG. 13 is a drawing showing a sectional view taken along a section indicated by line 13-13 in FIG. 12.

FIG. 14 is a drawing showing an elevational view of a VFFS machine in accordance with yet another embodiment of the invention.

FIG. 15 is a drawing showing a sectional view taken along a section indicated by line 15-15 in FIG. 14.

FIG. 16 is a drawing showing an elevational view of a VFFS machine in accordance with a further embodiment of the invention.

FIG. 17 is a drawing showing a sectional view taken along a section indicated by line 17-17 in FIG. 16.

FIG. 18 is a drawing showing a top view of the guide incorporated in the embodiment depicted in FIGS. 16 and 17.

Reference will now be made to the drawings in which similar elements in different drawings bear the same reference numerals.

### DETAILED DESCRIPTION OF THE INVENTION

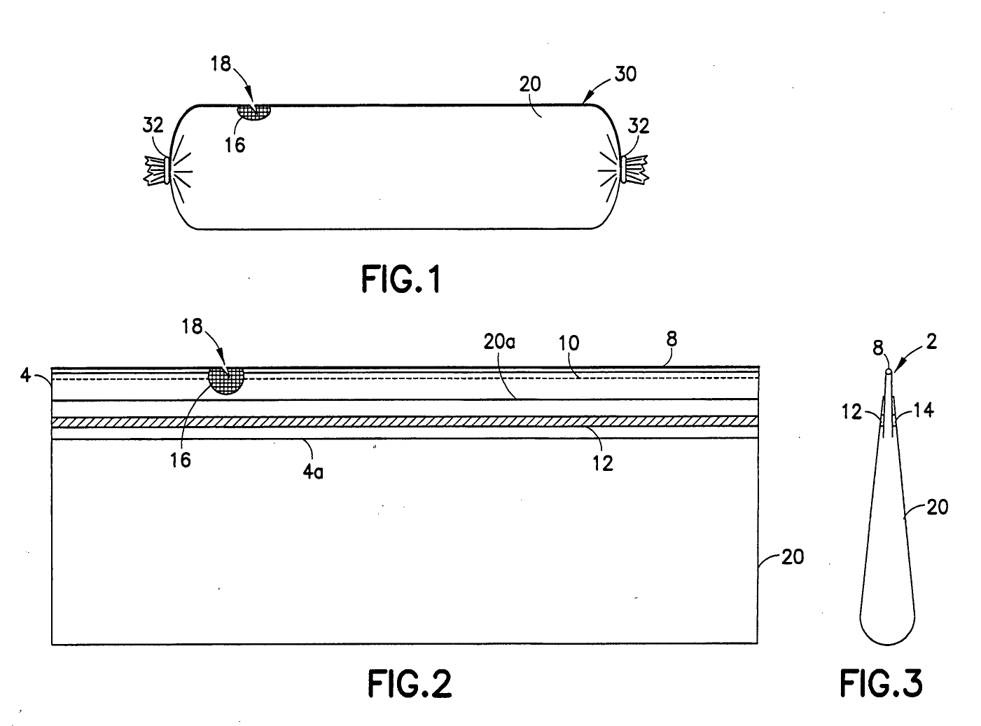

A dough package in accordance with one embodiment of the invention is depicted in FIGS. 1-3. As seen in FIG. 1, a mass of dough is wrapped in a sealed enclosure 30. The dough is in the shape of a circular cylinder with rounded ends.

FIGS. 2 and 3 show a length of a web 20 of packaging film not yet filled with dough and not yet closed at the ends, with an attached length of an easy-open closure tape 2. Although not shown in FIG. 3, the web of film will adopt the shape of the dough, in which case the web 20 will have a profile that is generally circular. As seen in FIG. 1, at the opposing ends of the dough, the ends of the web-tape assembly are gathered and clamped together by respective fasteners 32, which may take the form of malleable lengths of metal wire that are bent into a tight curve or spiral that squeezes the gathered portions of the web-tape assembly closed.

As best seen in FIG. 3, the sealed enclosure comprises an easy-open closure tape 2 attached to a web of packaging film 20 by means of a pair of permanent heat seals 12 and 14. Each permanent seal is a band-shaped zone of joinder where thermoplastic material of the web or the tape or both is fused following the application of heat and pressure. Referring to FIG. 2, one of the zones of joinder 12 is indicated by hatching. The horizontal line 4a represents one edge on one side of the easy-open closure tape 2 (assuming the web 20 to be optically transparent), while the horizontal line 20a represents one edge of the web 20. Alternatively, web 20 could be joined to the web 4 by a tie layer, adhesive, a bonding strip, etc.

In accordance with the embodiment of the invention depicted in FIGS. 2 and 3, the easy-open closure tape 2 has a tear bead 8 situated at the apex of a folded web 4, the two sides of the folded web 4 in turn being joined to respective portions of the web 20. As seen in FIG. 3, respective marginal portions of the closure tape web overlap the marginal portions of the web 20, and respective band-shaped portions of those overlapping marginal portions are heat sealed together to form the permanent seals 12 and 14. As best seen in FIG. 2, the closure tape further comprises an area 16 (hereinafter “fused area”) where respective mutually confronting portions of the folded web 4 are either fused to each other or fused to a flattened portion of the tear bead 8. A tear notch 18 is formed in the fused area 16, which tear notch severs the flattened portion of the tear bead 8, thereby providing a locus where tearing open of the sealed enclosure can be initiated. To facilitate tearing after the tear has been initiated, the closure tape is further provided with a pair of lines 10 of weakened tear resistance situated on opposite sides of the tear bead. One tear line 10 is indicated by a dashed line in FIG. 2. Thus the consumer is able to easily open the sealed dough package by grasping the closure tape 2 on one side of the encapsulated tear notch 18 and then pulling the portion of the closure tape above the tear line 10 and adjacent to tear notch toward one end of the closure tape. In this manner, the portion of the closure tape to the right of the tear notch 18 and above the tear line 10 (as seen in FIG. 2) can be removed, allowing access to the dough inside the package.

FIG. 2 shows a fused area 16 that has first and second edges on opposing sides of the mouth of the tear notch 18, and third and fourth edges that define the tear notch. The third and fourth edges meet each other at the apex of the tear notch, and meet the first and second edges respectively at the mouth of the tear notch. However, the invention does not require that the tear notch be formed in the fused area. Alternatively, the tear notch could be formed in an unfused area that is bounded by the fused area. For example, the fused area could be in the shape of half of an annular ring, with a tear notch being formed in the unfused semicircular area bounded by the half of an annular ring.

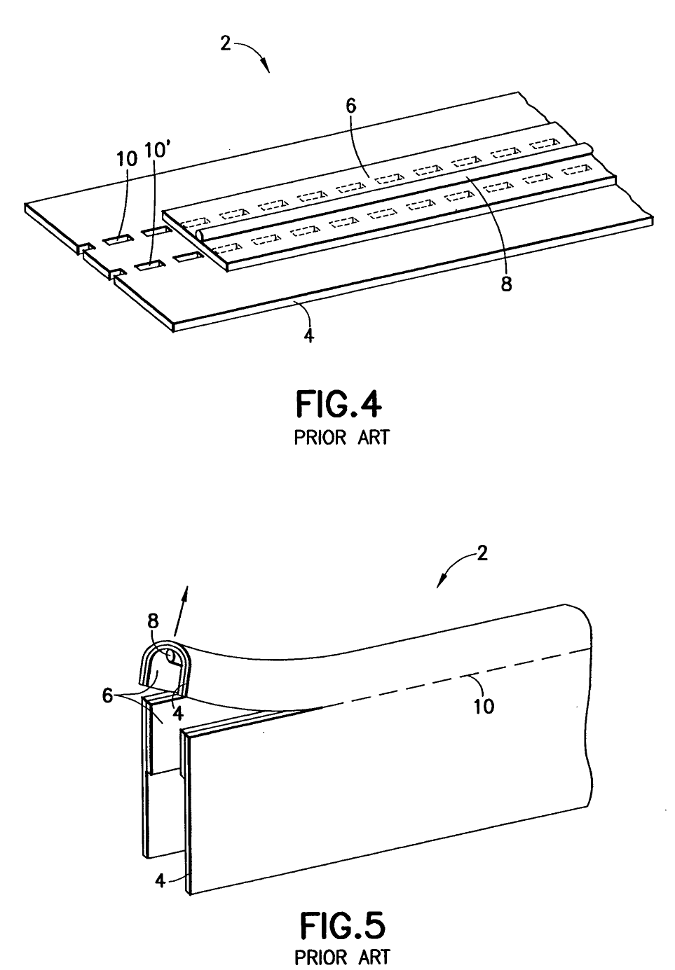

FIG. 4 is an isometric view of one embodiment of an easy-open closure tape (disclosed in U.S. Patent Application Publication No. 2003/0215165) that is suitable for adaptation (e.g., by providing an encapsulated tear notch) and incorporation in the dough package depicted in FIG. 1. This closure tape 2 comprises a base web 4 formed from a length of a thermoplastic polymer such as polyethylene, a length of paper-based material or a combination of the two materials (e.g., a laminate). Preferably, the thermoplastic polymer and paper-based material are not frangible. As used herein, the term “frangible” means that the material is easily broken or ruptured. Base web 4 has a pair of mutually parallel longitudinal edges and a pair of perforated tear lines (i.e., lines of spaced perforations) 10, 10′ running generally parallel to the longitudinal edges. Perforated tear lines 10, 10′ are located substantially equidistant from the longitudinal edges of the web and the perforations are spaced sufficiently close so that the tear lines will rupture upon the application of a tearing force to the tear lines.

Still referring to FIG. 4, attached to one side of base web 4 is a layer 6 made of a frangible thermoplastic film. Frangible layer 6 is positioned on one side of the base web 4 so as to obstruct (or seal) the perforations of tear lines 10, 10′. An example of a thermoplastic polymer suitable for use as the frangible layer 6 is ethylene vinyl acetate (EVA). Frangible layer 6 is attached to the base web 4 by any conventional technique, such as heat sealing, adhesive bonding, extrusion coating, etc. The method of choice for attaching the two layers will be partially dependent on the choice of material for base web 4. For example, if base web 4 is a thermoplastic polymer, frangible layer 6 can be adhered via heating sealing or via the use of a tie layer. Likewise, if base web 4 is a paper-based material, frangible layer 6 can be adhered thereto with an adhesive.

Frangible layer 6 has attached thereto a tear bead 8 on the side opposite from the base web 4. The tear bead 8 may be made of a generally tear-resistant material (i.e., non-frangible), such as a cloth string or plastic extrusion. The tear resistance of the tear bead 8 is greater than that of the perforated base web material 4. For example, the tear bead 8 may be formed from a tear-resistant thermoplastic polymer such as low-density polyethylene and may be attached by heat sealing, adhesive bonding or any other appropriate technique known in the art. The tear bead 8 is centrally located on frangible layer 6 between the respective positions of perforated tear lines 10, 10′ to substantially equalize the tearing force applied to tear lines 10, 10′ as tear bead 8 is pulled away from the bag.

FIG. 5 is an isometric view of the easy-open closure tape 2 in a folded and partially open (i.e., torn) state. Closure tape 2 is folded at a location between and along the same direction as perforated tear lines 10, 10′ so as to position frangible layer 6 and tear bead 8 within the interior of the folded closure tape 2, so that tear lines 10, 10′ are obstructed on the interior side of closure tape 2. As shown in FIG. 5, the top of closure tape 2 is removed by tearing along perforated tear lines 10, 10′ (10′ not shown in FIG. 2) by pulling along tear bead 8.

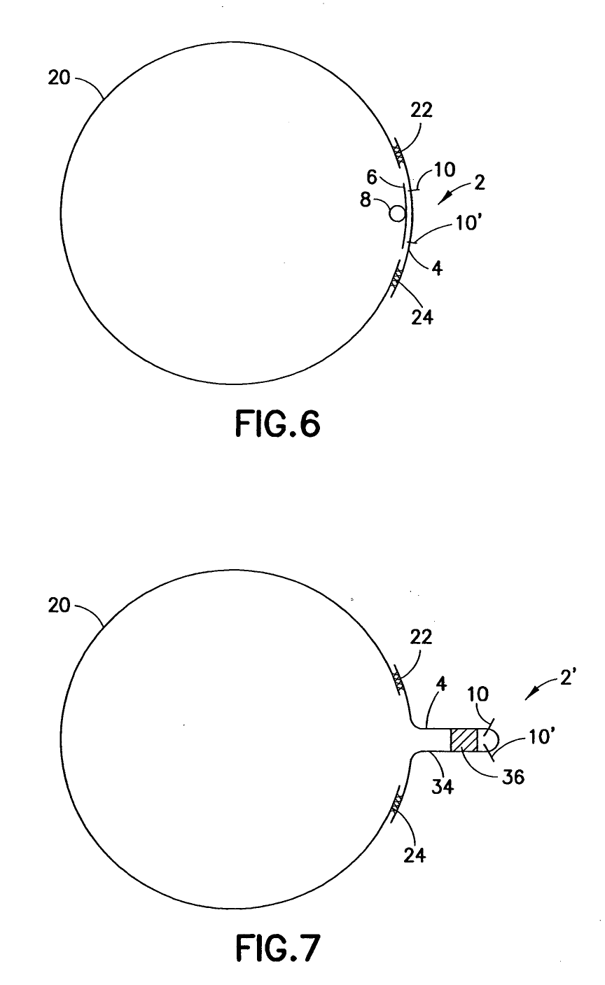

FIG. 6 is a cross-sectional view of one embodiment of a package incorporating a folded easy-open closure tape 2 of the type depicted in FIG. 5, but with an encapsulated tear notch (not shown in FIG. 6) added. As shown in FIG. 6, marginal portions of a base web 4 of a closure tape 2 are placed in overlapping relationship with marginal portions of a folded web 20 of packaging film. Within the zone of overlap, opposing portions of base web 4 are joined to opposing portions of the folded web 20 in respective band-shaped zones of joinder 22 and 24. The zones of joinder 22 and 24 can be formed by any conventional technique, such as heat sealing, adhesive, bonding strip, tie layer, ultrasonics, etc., dependent on the type of materials being used for webs 4 and 20.

The base web 4 is provided with a pair of perforated tear lines 10, 10′, which are covered by the frangible layer 6. The closure tape 2 is attached to the web 20 so that frangible layer 6 and tear bead 8 face the interior of the package. To facilitate opening of closure tape 2, the zones of joinder 22 and 24 are located below and do not overlap the perforated tear lines 10, 10′. The package depicted in FIG. 6 differs from that depicted in FIG. 3 (with due regard for the fact that the frangible layer of the closure tape is not shown in the latter) only in that the marginal portions of folded web 20 are placed between the marginal portions of base web 4, instead of vice versa.

FIG. 7 is a cross-sectional view of an embodiment of a package that incorporates a folded easy-open closure tape 2′ that has a peel seal 36 placed in a folded portion of a base web 4. Again, marginal portions of base web 4 are placed in overlapping relationship with marginal portions of a folded web 20 of packaging film. Within the zone of overlap, opposing portions of base web 4 are joined to opposing portions of the folded web 20 in respective band-shaped zones of joinder 22 and 24. The base web 4 is provided with a pair of perforated tear lines 10, 10′, which are not covered by a frangible layer. Instead the tear lines are placed so that they will be disposed on opposite sides of a loop portion of the base web 4 that arches over or shrouds the peel seal 36. Placement of the tear lines above the peel seal allows the consumer to tear off a top portion of the closure tape, thereby gaining access to the peel seal. Although not shown in FIG. 7, a tear bead can be provided at the apex of the loop to facilitate tearing off of the top portion of the closure tape 2′. Then the peel seal 36 can be peeled apart to gain access to the dough inside the package. The art of constructing a peel seal for use in reclosable packages is well known in the art.

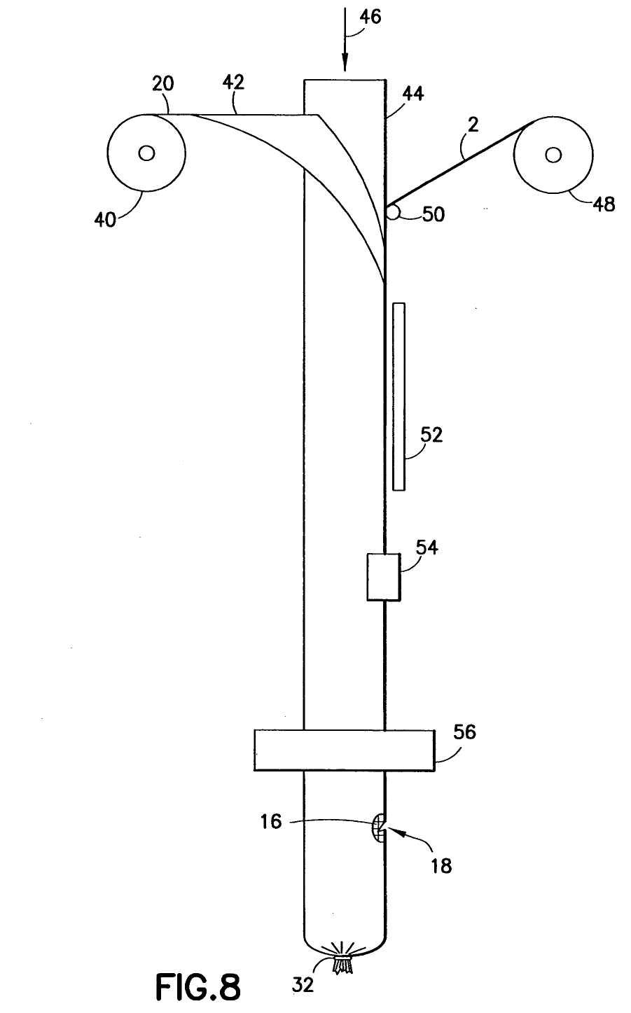

FIG. 8 is a drawing showing the basic construction of a VFFS machine that can be adapted for making either of the embodiments depicted in FIGS. 6 and 7. A web 20 of packaging film is fed from a continuous supply roll 40 into the VFFS machine, passed over a forming collar 42 and then wrapped around a fill tube 44 to bring the mutually parallel edges of the film web 20 to the respective positions seen in FIG. 6 or 7. The film passes through a generally circular gap (not seen in FIG. 8) between the forming collar 42 and the top of the fill tube 44 in a well-known manner. The fill tube 44 has an upper end through which dough is discharged to fall downwardly into individual packages, which downward movement of dough is indicated by arrow 46 in FIG. 8.

Still referring to FIG. 8, at the same time that the film web 20 is being fed, an easy-open closure tape 2 (of the type having perforated tear lines covered by a sealing strip) is fed from a continuous coil on a supply reel or spool 48. [Alternatively, the closure tape could be of the type having a peel seal and indicated by numeral 2′ in FIG. 7.] To manufacture either of the embodiments depicted in FIGS. 6 and 7, the web 20 is wrapped around the fill tube 44 with its marginal portions laid against the outer surface of the fill tube 44 and with a space between the mutually parallel edges of the web 20. The web 20 is advanced by being pulled down intermittently (by conventional means, such as drive belts that pull the web downward) in increments of advancement equal to the length of a package to be formed.

At the same time, the marginal portions of the base web of the closure tape 2 (or closure tape 2′ in FIG. 7) are guided into respective positions overlapping the marginal portions of web 20. This can be accomplished by placing a pair of guides (not shown in FIG. 8) alongside the fill tube 44. The guides are separated from the outer surface of the fill tube by respective narrow gaps through which the marginal portions of the web 20 and the closure tape 2 travel as they advance, i.e., are drawn downward.

After the marginal portions of the web and closure tape have been guided into overlapping relationship, those same marginal portions advance into a gap between the outer surface of the fill tube and respective reciprocatable heated vertical sealing bars 52, only one of which is visible in FIG. 8, that are in their retracted positions. During each dwell time, the pair of vertical sealing bars 52 are moved in unison from their retracted positions to respective extended positions. In their extended positions, the heated sealing bars soften or melt the thermoplastic material of one or both webs in the respective zones of overlap, following which the vertical sealing bars are retracted. The softened or molten material fuses upon cooling to form a pair of lap seals, such as seals 22 and 24 seen in FIG. 6 or 7. As a result of this operation, respective portions of the marginal portions of base web of the closure tape are joined to respective portions of the marginal portions of the web 20 within the zones of overlap, forming respective band-shaped zones of joinder 22 and 24 by which the closure tape is attached to the web wrapped around the fill tube.

Alternatively, the marginal portions of the web 20 do not lie against the outer surface of the fill tube, and instead are guided into mutually confronting radial positions by guiding means not shown in FIG. 8. These marginal portions of web 20 form fins that are disposed between (or outside) of the respective marginal portions of the base web of the closure tape. In accordance with this alternative embodiment, the zones of overlap are disposed between respective sides of a separator plate (not shown in the drawings) and respective reciprocatable heated vertical sealing bars oriented so that the heated contact surfaces of the sealing bars are in mutual opposition (as opposed to facing the outer surface of the fill tube, as was the case for the previously described embodiment). When in their respective extended positions, these sealing bars join respective portions of the marginal portions of the base web of closure tape 2 to respective portions of the fin portions of web 20, while the separator plate prevents seal-through of marginal portions of the web 20 to each other (in the case wherein those marginal portions are disposed between the marginal portions of the base web of closure tape 2) or seal-through of marginal portions of the base web of closure tape 2 to each other (in the case wherein those marginal portions are disposed between the marginal portions of the web 20) during the heat sealing operation.

Still referring to FIG. 8, after the closure tape 2 has been attached to the web 20 by the vertical sealing bars 52, a fuser of a fuser/notcher device 54 flattens a short section of the tear bead of the closure tape 2 and fuses first and second portions of the base web of the closure tape 2 to each other, while also fusing third and fourth portions of the base web of the closure tape to the flattened section of the tear bead. The first portion of the base web is contiguous with the third portion, while the second portion of the base web is contiguous with the fourth portion. Also a tear notch is cut in the base web by a notcher of the fuser/notcher device 54. Alternatively, the fuser and the notcher may be separate components located at different stations. FIG. 8 depicts the situation where a combined fuser/notcher device 54 is disposed downstream relative to the vertical sealing bars 52. The numeral 16 in FIG. 8 designates a fused area formed by the fuser, while numeral 18 designates the tear notch formed by the notcher.

In the particular embodiment depicted in FIG. 8, the tear notch is formed within the fused area. In accordance with alternative embodiments, the tear notch is formed in an unfused area that is bounded by a fused area (see discussion of FIG. 13 hereinafter). In either case, an “encapsulated” tear notch is formed, meaning that in the final dough-filled package the tear notch will be sealed off from the interior of the package.

Still referring to FIG. 8, after an encapsulated tear notch has been formed for a given section of the web/tape assembly, that section is advanced one package length. A tier/cutter unit 56 gathers a section of the web/tape assembly, ties off the opposing ends of that gathered section using respective fasteners 32, and then cuts across the gathered section of the web/tape assembly midway between the fasteners. The fastener 32 is a short length of ductile wire that is tightly wrapped around the gathered web/tape assembly, causing the top of the most recently filled package to be closed and forming a closed bottom end of the next package to be filled. The cross cut severs a completed dough package from the remainder of the work in process.

After the leading end of the not-yet-completed package has been tied, a package-length section of the web/tape assembly is filled with dough via the fill tube 44. This package-length section of the web/tape assembly is then advanced one package length, and then the tying/cross cutting operation is repeated to close the trailing end of the filled package and sever that filled package from the remainder of the work in process.

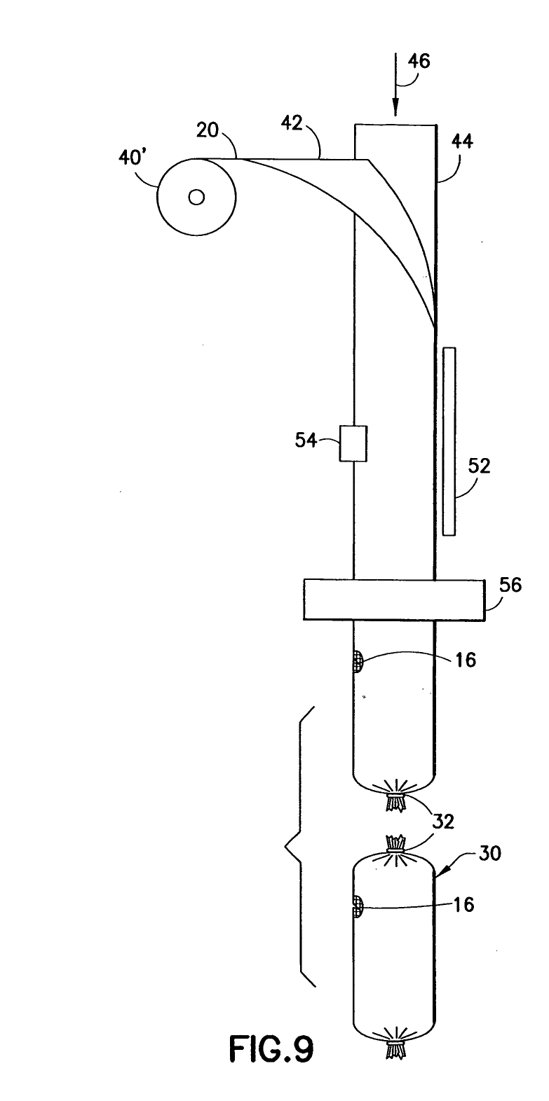

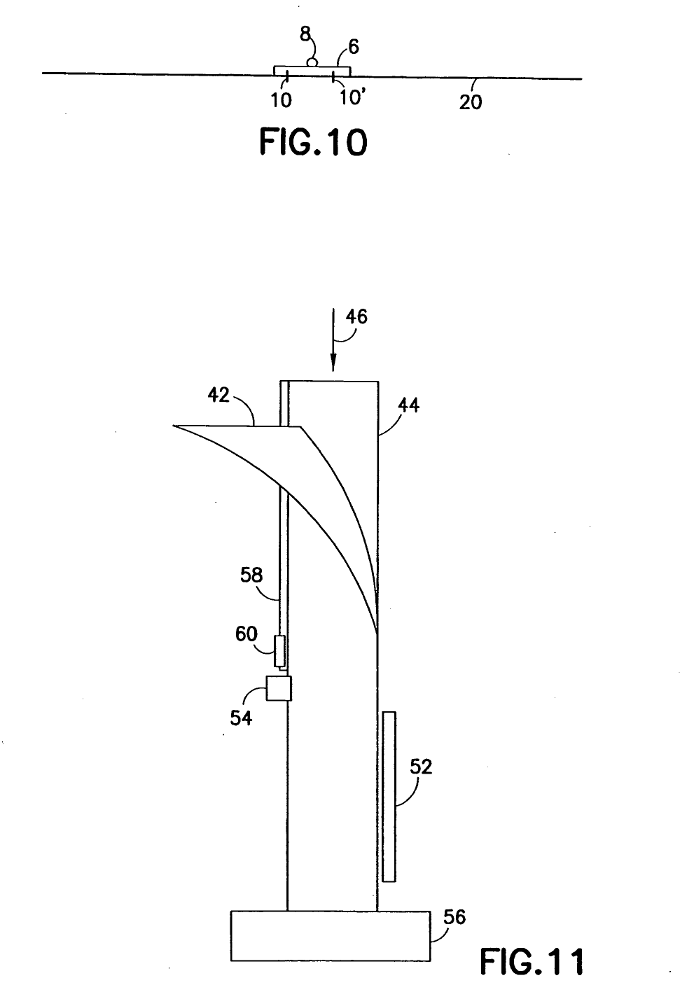

In accordance with a further embodiment depicted in FIGS. 9 and 10, a web 20 of packaging film having a pair of mutually parallel perforated tear lines 10, 10′ covered by a sealing strip 6 with a tear bead 8 attached thereto (see FIG. 10) is unwound from a continuous supply roll 40′ (see FIG. 9) and fed into an VFFS machine. For the sake of illustration, it will be assumed that the centerline of the sealing strip 6 overlies the centerline of the web 20, i.e., the sealing strip is midway between the edges of the web 20. This web is again passed over a forming collar 42 and then wrapped around a fill tube 44. The sealing strip 6 (see FIG. 10) is disposed on the side of the web 20 that faces the interior of the package. As the film web 20 is wrapped around the fill tube, the marginal portions of the web overlap and lie parallel to the axis of the fill tube on the outer surface (for forming a lap seal) or they are brought into a mutually confronting fin relationship, extending generally radially outward from the outer surface of the fill tube (for forming a fin seal). In the former case, a vertical sealing bar 52 forms a lap seal; in the latter case, a pair of vertical sealing bars form a fin seal. In either case, the web of film is now a tube that can be fused and notched to form an encapsulated tear notch, and then tied, filled and cut in the same manner previously described with respect to the embodiment depicted in FIG. 8.

FIG. 9 depicts the case wherein a combined fuser/notcher device 54 is disposed at a position diametrally opposite to the vertical sealing bars 52. However, the combined fuser/notcher device could alternatively be located upstream or downstream from the vertical sealing bars 52. In accordance with further variants, the fuser and notcher could be separate components located at different stations alongside the fill tube.

The fused area 16 seen in FIG. 9 comprises a flattened section of the tear bead 8 as well as two portions of the sealing strip (item 6 in FIG. 10) that have been fused together or to the flattened section of the tear bead by the fuser. The respective portions of the film web 20 that are already joined to the aforementioned two portions of the sealing strip are also fused in the fused area.

Still referring to FIG. 9, a tier/cutter unit 56 gathers a section of the web/tape assembly, ties off the ends of that gathered section and then cuts across the middle of the gathered section of the web/tape assembly. Again, the tying mechanism is a short length of flexible wire that is tightly wrapped around the gathered web/tape assembly. The cross cut severs a completed dough package 30 from the remainder of the work in process. Of the two ties that are applied during each tying operation, one tie 32 closes the trailing end of the just completed package, while the other tie 32 closes the leading end of the next (not yet completed) package.

FIG. 11 shows an elevational view of a VFFS machine in accordance with a further embodiment of the invention. In this embodiment, a fuser/notcher device 54 is disposed upstream of the vertical sealing bars 52. FIG. 11 shows a fin 58 extending down and along an upper portion of a fill tube 44 (having a constant circular cross section) and ending just before the fuser/notcher device 54. This creates slack film below the fin 58 that can be fused together to form the aforementioned fused area. Optionally, a folder 60, that will help bring two areas of the film into opposition so that they can be fused to each other, is placed near a section of fin 58, with a gap therebetween. The folder may be a U-shaped guide disposed such that the legs of the U extend parallel to the fin 58 and on opposite sides thereof (as seen in FIG. 15, which shows a different embodiment incorporating the same feature). The fin 58 and folder 60 define a U-shaped gap that guides and folds a portion of the web of packaging film into a loop as the web is advanced. A portion of the loop is then fused and notched by unit 54 in the manner previously described.

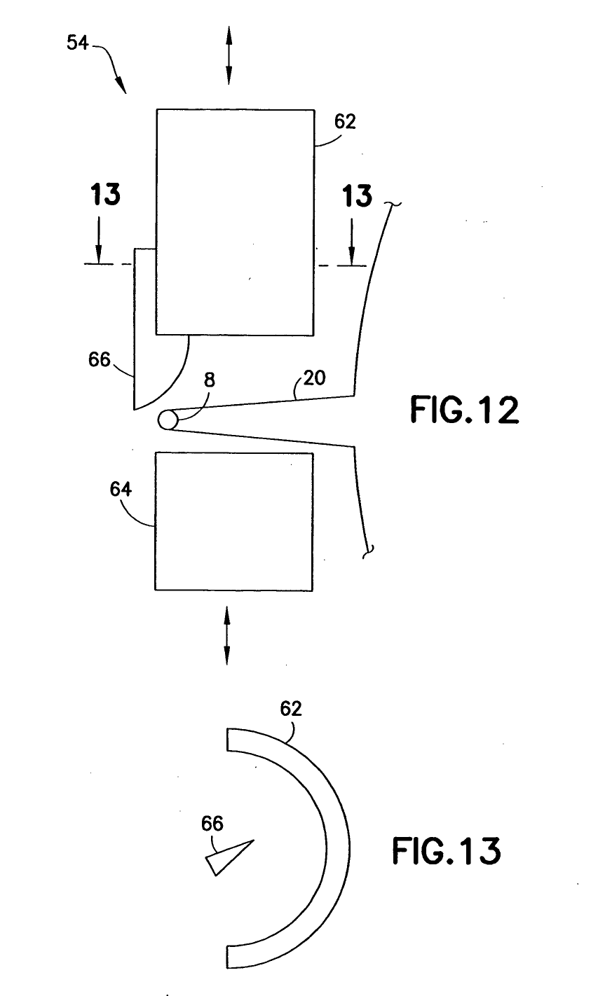

FIG. 12 shows a top view of an apparatus for fusing and notching in accordance with one embodiment, while FIG. 13 shows a sectional view taken along a section indicated by line 13-13 in FIG. 12. In accordance with this embodiment, the fuser/notcher device is positioned for manufacturing dough packages with the starting material depicted in FIG. 10. (The sealing strip has not been shown in order to avoid clutter in the drawing.) The fuser comprises a pair of mutually opposed reciprocatable elements 62 and 64, one or both of which may be heated. Element 62 has a semicircular contact surface of constant width, forming half of an annular ring, while element 64 takes the form of an anvil whose contact surface may be rectangular, the length of the rectangle being equal to or greater than the outer diameter of the half-annular contact surface of fuser element 62, while the width of the rectangle is equal to or greater than the outer radius of the half-annular contact surface of fuser element 62. When the two fuser elements 62 and 64 are in their extended positions, the contact surface of fuser element 62 presses against the contact surface of the anvil 64, with the folded extension that has been made in the film web (with the tear bead disposed in the apex of the fold) pressed therebetween. As seen in FIGS. 12 and 13, the fuser is positioned such that the opposing ends of the half-annular contact surface contact the tear bead 8 on opposing sides of the notcher 66. One or both contact surfaces is/are heated so that the thermoplastic film of web 20 is fused to itself and to the tear bead 8 along a half-annular region that bounds a semicircular unfused area. The tear bead is flattened in the two regions where the annular contact surface of fuser element 62 bears against the bead. Still referring to FIGS. 12 and 13, the tear notch is formed in the semicircular unfused area by means of a V-shaped blade of notcher 66 that makes a V-shaped cutout. The notcher 66 is mechanically coupled to the fuser element 62 so that they reciprocate in unison. The C-shaped seal formed by the fuser encapsulates the notch cut in the folded extension, forming a sealed barrier that prevents air from entering the package via the tear notch.

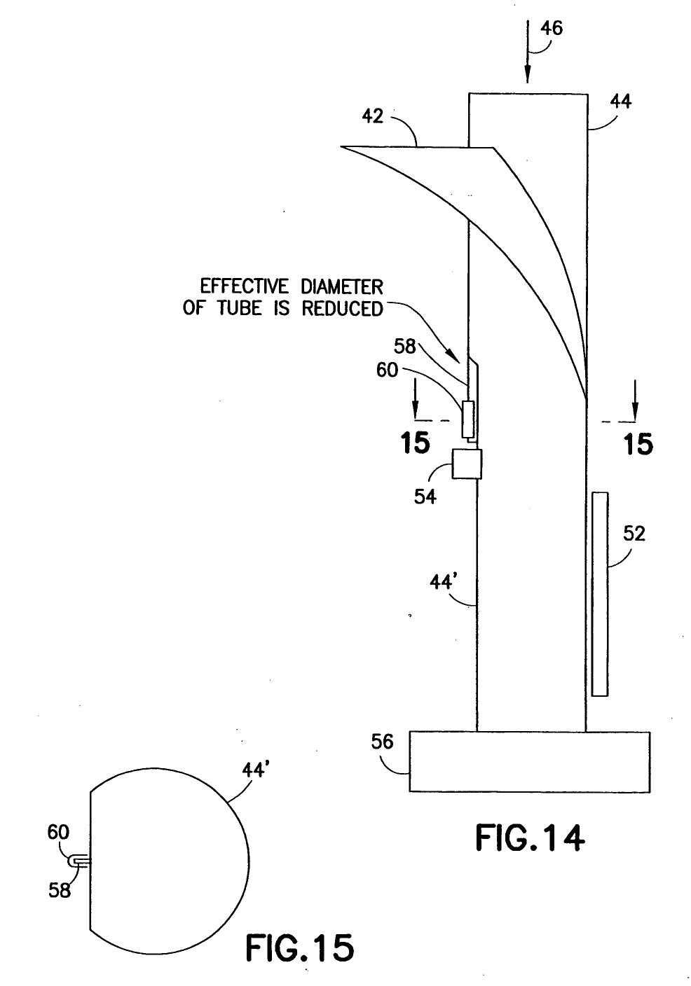

In the embodiment of FIG. 11, slack in the packaging film was created by a radial fin projecting from an upper portion of a constant-diameter fill tube. In contrast, FIGS. 14 and 15 show the effective circumference of the fill tube 44 being reduced in order to create slack film that can be formed around a fin 58 that has been placed on the narrower portion 44′ of the fill tube. FIG. 15 shows a sectional view taken along a section indicated by line 15-15 in FIG. 14. As seen in FIG. 15, the lower portion 44′ of the fill tube has a perimeter that is reduced due to the provision of a flat section in place of a curved section of the circular fill tube. The fin 58 projects from the flat section at substantially right angles. The folder 60 assists in bringing two areas of the film into opposition so that they can be fused to each other. The folder 60 seen in FIG. 15 is a U-shaped guide disposed such that the legs of the U extend parallel to the fin 58 and on opposite sides thereof. The fin 58 and folder 60 define a U-shaped gap that guides and folds a portion of the web of packaging film into a loop as the web is advanced. A portion of the loop is then fused and notched by unit 54, and the web/tape assembly is then tied, filled and cut in the same manner as previously described.

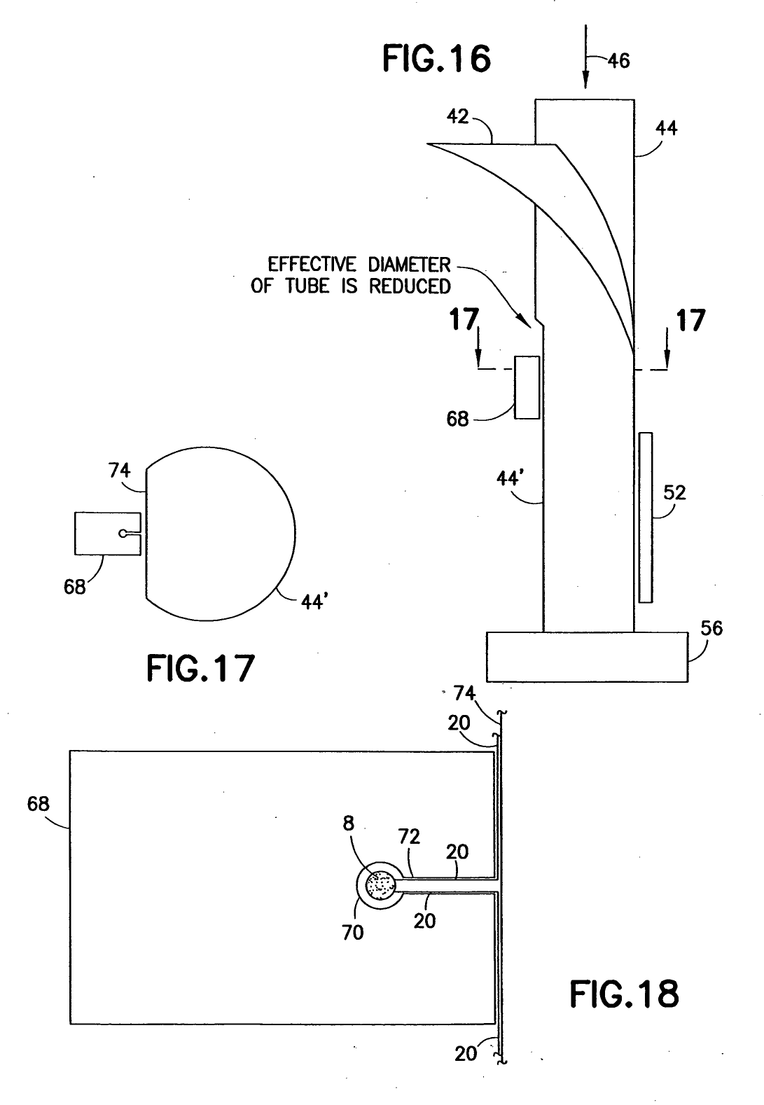

FIG. 16 shows an elevational view of a VFFS machine in accordance with a further embodiment of the invention. The upper portion of the fill tube 44 has a circular cross section. The lower portion 44′ of the fill tube has a perimeter that is reduced due to the provision of a flat section 74 (seen in the sectional view of FIG. 17) in place of a curved section of the circular fill tube. Item 68 in FIG. 16 represents a guide device that incorporates a fuser/notcher device. FIG. 18 shows a top view of the guide device incorporated in the embodiment depicted in FIGS. 16 and 17. The guide device 68 comprises a slot 72 that runs the length of the guide and is substantially perpendicular to the face of the flat section 74. The slot 72 communicates with substantially circular channel 70 having a diameter greater than the width of the slot 72. The slot 72 is wide enough to pass two thicknesses of the web 20 but is significantly narrower than the thickness of the tear bead 8. The channel 70 is provided to accommodate the tear bead 8, which in this example is attached to a sealing strip not shown, which sealing strip is in turn joined to a film web 20, as previously described with reference to FIG. 10. The tear bead 8 riding in the channel 70 maintains tension on the web 20, in lieu of a fin on the fill tube, and brings two areas of the web 20 into opposition. A fuser/notcher (e.g., of the type shown in FIG. 12) can be incorporated into the guide device 68 to act on this folded section.

In the embodiments depicted in FIGS. 11, 14 and 16, the fuser/notcher device is positioned for manufacturing dough packages starting with the web depicted in FIG. 10. However, it should be appreciated that the fuser/notcher can be readily re-positioned on the other side of the fill tube for manufacturing dough packages of the type shown in FIGS. 6 and 7. In the case where a guide device 68 of the type shown in FIG. 18 is used, the tear bead of a closure tape (attached to a web) will ride in the channel 70.

While the invention has been described with reference to certain embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the verb “joined” means fused, bonded, sealed, adhered, etc., whether by application of heat and/or pressure, application of ultrasonic energy, application of a layer of adhesive material or bonding agent, interposition of an adhesive or bonding strip, etc. Furthermore, in the absence of explicit language in any method claim setting forth the order in which certain steps should be performed, the method claims should not be construed to require that steps be performed in the order in which they are recited.

1. A package comprising:
a generally cylindrically shaped mass of dough comprising a central section and opposite ends; and
a sealed enclosure that encloses said mass of dough and comprises a tear notch,
wherein first and second portions of said sealed enclosure are fused together within a fused area that comprises first and second edges extending in parallel in opposite directions from opposing corners of a mouth of said tear notch.

2. The package as recited in claim 1, wherein said tear notch is defined by third and fourth edges of said fused area that meet at a tip of said tear notch, another end of said third edge meeting said first edge at a first juncture, and another end of said fourth edge meeting said second edge at a second juncture.

3. The package as recited in claim 1, wherein said tear notch is separated from said fused area by unfused portions of said sealed enclosure.

4. The package as recited in claim 1, wherein said fused area is arc-shaped.

5. The package as recited in claim 1, further comprising a length of a tear bead joined to said sealed enclosure, wherein third and fourth portions of said sealed enclosure and a flattened portion of said tear bead are fused together within said fused area, said third portion being contiguous with said first portion of said sealed enclosure, and said fourth portion being contiguous with said second portion of said sealed enclosure.

6. The package as recited in claim 5, wherein said sealed enclosure comprises:
a length of a web of packaging material surrounding said mass of material, said length of said web comprising first and second edges that each extend from a respective point on one side of said central section to a respective point on the other side of said central section, and further comprising first and second marginal portions adjacent said first and second edges respectively;
a length of tape comprising first and second portions that are joined to said first and second marginal portions respectively or to respective portions of said first and second marginal portions along said length of said web, and further comprising a third portion disposed between said first and second portions, at least a portion of said third portion of said length of tape being exposed and accessible to a consumer along a portion of said length of said web, said length of tear bead being joined to said third portion of said length of tape, and said first and second portions of said sealed enclosure being respective portions of said third portion of said length of tape; and
first and second closures for closing said joined web and tape at said opposite ends of said mass of material.

7. The package as recited in claim 6, wherein said length of tape further comprises first and second lines of weakened tear resistance, said first line of weakened tear resistance being disposed between said tear bead and said first portion of said tape, and said second line of weakened tear resistance being disposed between said tear bead and said second portion of said length of tape.

8. The package as recited in claim 6, further comprising a length of peel seal material joined to fourth and fifth portions of said length of tape, said fourth portion being disposed between said first and third portions of said length of tape, and said fifth portion being disposed between said second and third portions of said length of tape.

9. The package as recited in claim 1, wherein said sealed enclosure comprises:
a length of a web of packaging material surrounding said mass of material, said length of said web comprising first and second edges that each extend from a respective point on one side of said central section to a respective point on the other side of said central section, and further comprising first and second marginal portions adjacent said first and second edges respectively, respective portions of said first and second marginal portions being joined to each other, and a portion disposed in the area between said first and second marginal portions and having first and second tear lines each comprising a respective series of spaced perforations;
a length of a sealing strip that caps said perforations of said first and second tear lines, said length of tear bead being joined to said length of sealing strip; and
first and second closures for closing said length of said web at said opposite ends of said mass of material.

10. The package as recited in claim 1, wherein said mass of material is dough.

11. The package as recited in claim 1, wherein said central section of said mass of material is substantially cylindrical in shape and said opposite ends of said mass of material are generally rounded.

12. A package comprising:
a generally cylindrically shaped mass of material comprising a central section and opposite ends;
a sealed enclosure that encloses said mass of material and comprises a tear notch; and
a tear bead joined to said sealed enclosure and extending in a lengthwise direction along at least a portion of the length of said mass of material,
wherein said sealed enclosure further comprises a fused area that comprises first and second edges extending in parallel in opposite directions from opposing corners of a mouth of said tear notch, said tear bead comprising first and second flattened portions in said fused area, said first flattened portion of said tear bead being adjacent said first edge of said fused area and said second flattened portion of said tear bead being adjacent said second edge of said fused area.

13. The package as recited in claim 12, wherein said tear notch is defined by third and fourth edges of said fused area that meet at a tip of said tear notch, another end of said third edge meeting said first edge at a first juncture, and another end of said fourth edge meeting said second edge at a second juncture.

14. The package as recited in claim 12, wherein said tear notch is separated from said fused area by unfused portions of said sealed enclosure.

15. The package as recited in claim 12, wherein said fused area is arc-shaped.

16. The package as recited in claim 12, further comprising a length of peel seal material joined to said sealed enclosure, said length of peel seal material being spaced apart from said tear bead by a substantially constant distance.

17. The package as recited in claim 12, wherein said sealed enclosure further comprises first and second tear lines each comprising a respective series of spaced perforations, further comprising a length of a sealing strip that caps said perforations of said first and second tear lines, said length of tear bead being joined to said length of sealing strip.

18. The package as recited in claim 12, wherein said mass of material is dough.

19. A package comprising:
a mass of material comprising a central section and opposite ends;
a length of a web of packaging material surrounding said mass of material, said length of said web comprising first and second edges that each extend from a respective point on one side of said central section to a respective point on the other side of said central section, and further comprising first and second marginal portions adjacent said first and second edges respectively;
a length of tape comprising first and second portions that are joined to said first and second marginal portions respectively or to respective portions of said first and second marginal portions along said length of said web, and further comprising a third portion disposed between said first and second portions, said third portion of said length of tape being exposed and accessible to a consumer along a portion of said length of said web and comprising a fused area having or partly encircling a tear notch; and
first and second closures for closing said joined web and tape at said opposite ends of said mass of material.

20. The package as recited in claim 19, further comprising a length of tear bead joined to said length of tape and passing through said fused area, said tear bead being flattened in said fused area.

21. The package as recited in claim 19, wherein said length of tape further comprises first and second lines of weakened tear resistance, said first line of weakened tear resistance being disposed between said tear bead and said first portion of said tape, and said second line of weakened tear resistance being disposed between said tear bead and said second portion of said length of tape.

22. The package as recited in claim 21, wherein said first line of weakened tear resistance comprises a series of spaced perforations, further comprising a length of a sealing strip that caps said perforations.

23. The package as recited in claim 21, wherein said first and second lines of weakened tear resistance comprise respective scorelines.

24. The package as recited in claim 19, further comprising a length of peel seal material joined to fourth and fifth portions of said length of tape, said fourth portion being disposed between said first and third portions of said length of tape, and said fifth portion being disposed between said second and third portions of said length of tape.

25. The package as recited in claim 24, wherein said length of tape comprises first and second lines of weakened tear resistance disposed between said fourth and fifth portions of said length of tape.

26. The package as recited in claim 25, further comprising a length of tear bead joined to said length of tape and passing through said fused area, said tear bead being flattened in said fused area.

27. The package as recited in claim 19, wherein said mass of material is dough.

28. A package comprising:
a mass of material comprising a central section and opposite ends;
a length of a web of packaging material surrounding said mass of material, said length of said web comprising first and second edges that each extend from a respective point on one side of said central section to a respective point on the other side of said central section, and further comprising first and second marginal portions adjacent said first and second edges respectively, respective portions of said first and second marginal portions being joined to each other, and a portion disposed in the area between said first and second marginal portions and having first and second tear lines each comprising a respective series of spaced perforations;
a length of a sealing strip that caps said perforations of said first and second tear lines;
a length of tear bead joined to a portion of said sealing strip located between said first and second tear lines; and
first and second closures for closing said web at said opposite ends of said mass of material,
wherein first and second portions of said sealing strip and a flattened portion of said tear bead are fused within a fused area having or partly encircling a tear notch.

29. The package as recited in claim 28, wherein said mass of material is dough.

30. A method of manufacture comprising the following steps:
(a) guiding a web of packaging material in a machine direction through a vertical form-fill-seal (VFFS) machine with a portion of said web being wrapped around a tube;
(b) fusing first and second portions of a length of tape together to form a fused area;
(c) forming a tear notch in said fused area or in an area partly encircled by said fused area;
(d) joining third and fourth portions of said length of tape to first and second portions of an equal length of said web to form a tube-shaped length of a tape-web assembly;
(e) closing one end of said length of tape-web assembly at a location downstream from said tube; and
(f) dropping product through said tube and onto said closed end.

31. The method as recited in claim 30, further comprising the step of closing the other end of said length of tape-web assembly after step (f) has been completed.

32. The method as recited in claim 31, further comprising the steps of cutting said length of tape-web assembly along a first line located below said product and along a second line located above said product, said cut along said second line severing a completed package from the work in process.

33. The method as recited in claim 30, further comprising the step of joining a length of a tear bead to said length of tape before any of steps (b) through (e) are performed.

34. The method as recited in claim 30, further comprising the step of joining a length of peel seal material to said length of tape before any of steps (b) through (e) are performed.

35. The method as recited in claim 30, further comprising the steps of forming first and second lines of weakened tear resistance in parallel in said length of tape before any of steps (b) through (e) are performed.

36. The method as recited in claim 35, wherein each of said first and second lines of weakened tear resistance comprises a respective series of spaced perforations, further comprising the step of capping said perforations before any of steps (b) through (e) are performed.

37. A method of manufacture comprising the following steps:
(a) forming first and second lines of spaced perforations in parallel in a web of packaging material;
(b) joining a sealing strip to said web, said sealing strip capping said perforations;
(c) joining a tear bead to said sealing strip;
(d) guiding said web with said sealing strip and said tear bead thereon in a machine direction through a vertical form-fill-seal (VFFS) machine with a portion of said web being wrapped around a tube;
(e) fusing first and second portions of said sealing strip and a flattened portion of said tear bead together to form a fused area;
(f) forming a tear notch in said fused area or in an area partly encircled by said fused area;
(g) closing one end of a length of said web at a location downstream from said tube; and
(h) dropping product through said tube and onto said closed end.

38. The method as recited in claim 37, further comprising the step of closing the other end of said length of web after step (h) has been completed.

39. The method as recited in claim 38, further comprising the steps of cutting said length of web along a first line located below said product and along a second line located above said product, said cut along said second line severing a completed package from the work in process.

40. A generally tube-shaped package comprising a tear strip joined to a web of packaging film, said tear strip incorporating an encapsulated tear notch.

41. The package as recited in claim 40, wherein said package is filled with dough.
